(19) United States
(12) Patent Application Publication
(10) Pub. No.: US 2019/0129268 A1
(43) Pub. Date: May 2, 2019

(54) METHOD FOR MANUFACTURING COLOR FILTER SUBSTRATE

(71) Applicant: WUHAN CHINA STAR OPTOELECTRONICS SEMICONDUCTOR DISPLAY TECHNOLOGY CO., LTD., Wuhan, Hubei (CN)

(72) Inventors: Xiaoguang ZHU, Wuhan, Hubei (CN); Chewen TSAI, Wuhan, Hubei (CN); Mengqi CAI, Wuhan, Hubei (CN)

(21) Appl. No.: 15/740,007

(22) PCT Filed: Nov. 24, 2017
(86) PCT No.: PCT/CN2017/112886

§ 371 Date: Dec. 27, 2017

(30) Foreign Application Priority Data
Oct. 27, 2017 (CN) 201711018541.7

(51) Int. Cl. G02F 1/167; G02F 1/1333; G02F 1/1335

(52) U.S. Cl. CPC G02F 1/167; G02F 1/133512; G02F 1/133305

(57) ABSTRACT

A display panel motherboard and a cutting method for the display panel motherboard are provided in the present disclosure. The display panel motherboard includes a rigid substrate, a flexible substrate, and a fixing layer. The flexible substrate including a cutting region and a non-cutting region; the flexible substrate in the non-cutting region is adhered to the rigid substrate; and the fixing layer is disposed between the flexible substrate in the cutting region and the rigid substrate, the fixing layer is configured to fix the flexible substrate on the rigid substrate when the flexible substrate in the non-cutting region and the rigid substrate are stripped off, and the flexible substrate is cut along the cutting region of the flexible substrate. The method is achieved by disposing a fixing layer between the flexible substrate in the cutting region and the rigid substrate of the display panel motherboard, to increase cutting efficiency.

### FIELD OF INVENTION

The present disclosure relates to a technical field of displays, and particularly to a display panel motherboard and a cutting method for the display panel motherboard.

### BACKGROUND OF INVENTION

Substrates are generally made of glass in traditional display devices. Display devices, made of rigid substrates, are less resistant to stress due to rigid substrates being brittle and not flexible. In contrast, since flexible substrates have flexible characteristics. Display devices made of the flexible substrates have gradually become mainstream technology.

Limited to current screen manufacturing process, a flexible substrate needs to use a rigid substrate as a supporting substrate during a screen manufacturing process of the flexible substrate. Specifically, first, the flexible substrate is stripped off from the rigid substrate by technology of laser lift off. Then, the flexible substrate is cut according to a demanded size of the screen by laser cutting technology. Finally, the flexible substrate is separated from the rigid substrate to obtain a flexible screen. However, during the laser lift off process, the obtained flexible substrate is relatively soft, which is an adverse condition in which to deliver the substrate in the production line. In addition, during the subsequent laser cutting process, a flexible substrate, which is too soft, is easy to warp and wrinkle.

### SUMMARY OF INVENTION

An object of the present disclosure is to provide a display panel motherboard which can increase a cutting efficiency of the display panel motherboard.

A display panel motherboard is provided in an embodiment of the present disclosure, which includes: a rigid substrate, a flexible substrate, and a fixing layer, the flexible substrate comprising a cutting region and a non-cutting region;

wherein a part of the flexible substrate in the non-cutting region is adhered to the rigid substrate; and
wherein the fixing layer is disposed between the flexible substrate in the cutting region and the rigid substrate, the fixing layer is configured to fix the flexible substrate on the rigid substrate when the part of the flexible substrate in the non-cutting region and the rigid substrate are stripped off, and the flexible substrate is cut along the cutting region of the flexible substrate.

In some embodiments, an adhering strength between the fixing layer and the flexible substrate ranges from 1 to 20 gram-force/foot.

In some embodiments, the fixing layer is made of an opaque material.

In some embodiments, the cutting region includes a plurality of cutting sub-regions, the fixing layer includes a plurality of fixing portions corresponding to parts of the flexible substrate in the cutting sub-regions; and the fixing portions are arranged adjacently or spaced apart.

In some embodiments, a bottom of one of the fixing portions has a long-bar shape, a round shape, a square shape, or a rounded-square shape.

In some embodiments, the fixing layer comprises a fixing sub-layer and a light-shielding sub-layer, the light-shielding sub-layer is disposed on the rigid substrate; and the fixing sub-layer is disposed between the flexible substrate and the light-shielding sub-layer.

In some embodiments, an adhering strength between the part of the flexible substrate in the non-cutting region and the rigid substrate is greater than 50 gram-force/foot.

In some embodiments, the display panel motherboard further includes a drive circuit layer and a display medium layer; the drive circuit layer is disposed on the flexible substrate; and the display medium layer is disposed on the drive circuit layer.

A cutting method for a display panel motherboard is further provided in an embodiment of the present disclosure, the method is configured to cut the display panel motherboard as mentioned above, and includes:

stripping off the part of the flexible substrate in the non-cutting region, and the rigid substrate; and
cutting the flexible substrate along the cutting region of the flexible substrate until the fixing layer is contacted.

In some embodiments, after stripping off the part of the flexible substrate in the non-cutting region and the rigid substrate, the cutting method further includes cutting the flexible substrate along the cutting region of the flexible substrate until the cutting extends to the rigid substrate.

A display panel motherboard and a cutting method for the display panel motherboard are provided in embodiments of the present disclosure. The display panel motherboard is produced by disposing the fixing layer between the flexible substrate in the cutting region and the rigid substrate of the display panel motherboard, to fix the flexible substrate on the rigid substrate when the part of the flexible substrate in the non-cutting region and the rigid substrate are stripped off, and the flexible substrate is cut along the cutting region of the flexible substrate, so as to increase a cutting efficiency.

In order to make the above contents of the present disclosure more comprehensible and understandable, the preferred embodiments are described below in detail with reference to the accompanying drawings.

### BRIEF DESCRIPTION OF DRAWINGS

FIG. 1 is a schematic view of a first structure of a display panel motherboard provided in an embodiment of the present disclosure.

FIG. 2 is a schematic view of a second structure of a display panel motherboard provided in an embodiment of the present disclosure.

FIG. 3 is a schematic view of a third structure of a display panel motherboard provided in an embodiment of the present disclosure.

FIG. 4 is a schematic view of a fourth structure of a display panel motherboard provided in an embodiment of the present disclosure.

FIG. 5 is a schematic view of a fifth structure of a display panel motherboard provided in an embodiment of the present disclosure.

FIG. 6 is a flowchart of a cutting method for the display panel motherboard provided in an embodiment of the present disclosure.

FIG. 7 is a schematic view of a scene of a cutting method for the display panel motherboard provided in an embodiment of the present disclosure.

FIG. 8 is a schematic view of another scene of a cutting method for the display panel motherboard provided in an embodiment of the present disclosure.

### DETAILED DESCRIPTION OF PREFERRED EMBODIMENTS

The following description of each embodiment refers to the appended drawings for illustrating specific embodiments in which the present disclosure may be practiced. Directional terms as mentioned in the present disclosure, such as “up”, “down”, “front”, “post”, “left”, “right”, “inside”, “outside”, “lateral”, etc., are merely used for the purpose of illustrating and understanding the present disclosure and are not intended to be limiting of the present disclosure.

In the drawings, units with similar structures are denoted by the same reference numerals.

Referring herein to “an embodiment” means that a particular feature, structure, or characteristic described in connection with the embodiment may be included in at least one embodiment of the disclosure. The appearances of the phrase in various places in the specification are not necessarily all referring to the same embodiment, nor are separate or alternative embodiments mutually exclusive of other embodiments. The explicit and implicit understanding to a person having ordinary skill in the art is that the embodiments described herein may be combined with other embodiments.

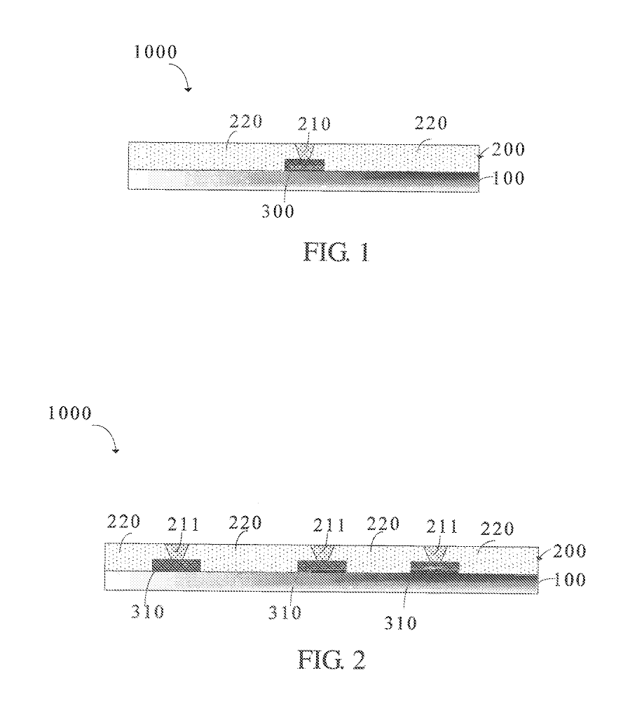

Refer to FIG. 1, which is a schematic view of a first structure of a display panel motherboard provided in an embodiment of the present disclosure. FIG. 1 illustrates that a display panel motherboard 1000 includes a rigid substrate 100, a flexible substrate 200, and a fixing layer 300.

The flexible substrate 200 is made of one or a combination of materials such as polyimide, polyetherimide, polyphenylene sulfide, and polyarylate. The flexible substrate 200 may be transparent or opaque. According to the size of the display panel needing to be manufactured, the flexible substrate 200 may be divided into a cutting region 210 and a non-cutting region 220, and a part of the flexible substrate 200 located in the cutting region 210 is used to perform a cutting operation.

The rigid substrate 100 may be a glass substrate for carrying and supporting the flexible substrate 200. In this embodiment, the part of the flexible substrate 200 located in the cutting region 210 is adhered to the rigid substrate 100, wherein an adhering strength between the part of the flexible substrate 200 located in the non-cutting region 220 and the rigid substrate 100 is greater than 50 gram-force/foot.

The fixing layer 300 is disposed between the cutting region 210 and the rigid substrate 100, the fixing layer 300 is configured to fix the flexible substrate 200 on the rigid substrate 100 when the part of the flexible substrate 200 in the non-cutting region 220 and the rigid substrate 100 are stripped off, and the flexible substrate 200 is cut along the cutting region 210 of the flexible substrate 200.

In some embodiments, the fixing layer 300 is made of an opaque material such as metal, metal alloy, etc., in order to shield a penetrating laser during a laser lift off process, namely, the fixing layer 300 will not be stripped off from the rigid substrate 100 and the flexible substrate 200. Since the flexible substrate 200 is still adhered to the rigid substrate 100 through the fixing layer 300, the flexible substrate 200 which is not aligned to be cut due to being dangling has been avoided. In addition, when the flexible substrate 200 is cut into a plurality of flexible daughterboards, the rigid substrate 100 is only required to adsorb by an adsorption stage, and the flexible substrate 200 is only cut by laser, without the process of splitting. Thus, it greatly improves the cutting efficiency and reduces costs.

In some embodiments, an adhering strength between the fixing layer 300 and the flexible substrate 200 is smaller, which ranges from 1 to 20 gram-force/foot. After the flexible substrate 200 is cut into the flexible daughterboards, the fixing layer 300 is able to glue the single flexible daughterboard on the rigid substrate, so as to avoid the dislocation of the single flexible daughterboard following the cutting process. In addition, when the flexible daughterboard and the rigid substrate 100 are separated, the fixing layer 300 and the flexible substrate 200 may also be separated by mechanical lift off technology.

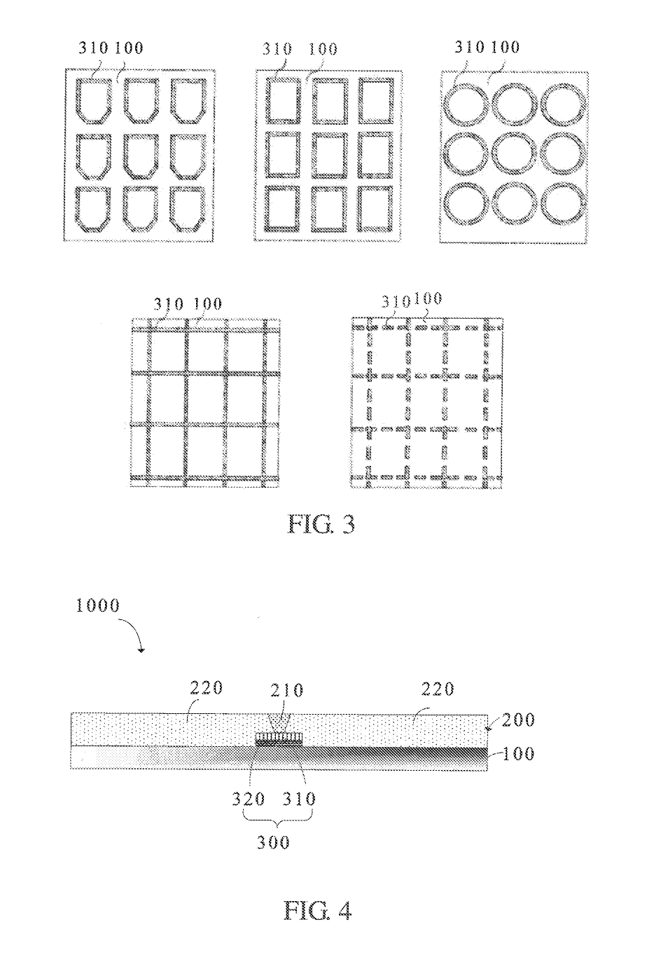

In some embodiments, as shown in FIG. 2, the cutting region 210 includes a plurality of cutting sub-regions 211, the fixing layer 300 includes a plurality of fixing portions 310 corresponding to parts of the flexible substrate 200 in the cutting sub-regions 211. As shown in FIG. 3, those fixing portions 310 are arranged adjacently or spaced apart, wherein a bottom of one of the fixing portions 310 has a shape such as a long-bar shape, a round shape, a square shape, or a rounded-square shape, and the height range of the fixing portions 310 is scaled from narometer to micron, it can be adjusted according to actual conditions.

In some embodiments, as shown in FIG. 4, the fixing layer 300 comprises a fixing sub-layer 310 and a light-shielding sub-layer 320; the light-shielding sub-layer 320 is disposed on the rigid substrate 100, the thickness range of the light-shielding sub-layer 320 is scaled from narometer to micron, and the light-shielding sub-layer 320 is made of an opaque material such as metal, metal alloy, etc., in order to shield the penetrating laser during the laser lift off process.

The fixing sub-layer 310 is disposed between the flexible substrate 200 and the light-shielding sub-layer 320, the thickness range of the fixing sub-layer 310 is scaled from narometer to micron, and the fixing sub-layer 310 is made of a transparent material such as inorganic substances, fluorine organic compounds, etc., wherein an adhering strength between the fixing sub-layer 310 and the flexible substrate 200 ranges from 1 to 20 gram-force/foot.

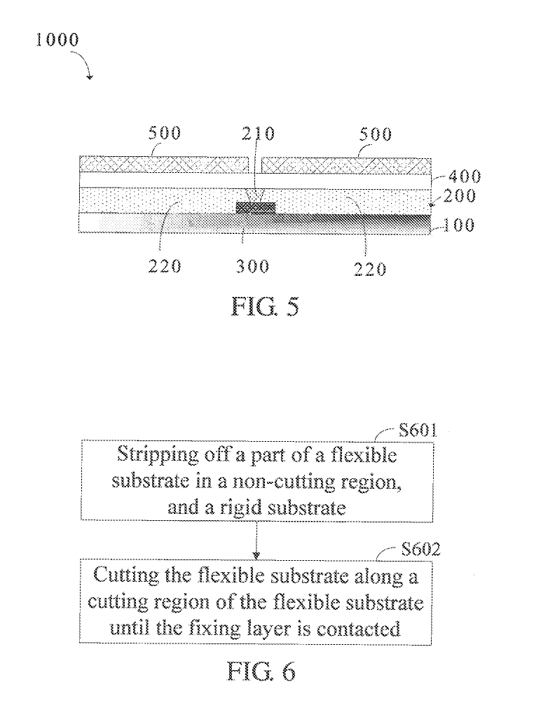

In some embodiments, as shown in FIG. 5, the display panel motherboard 1000 further includes a drive circuit layer 400 and a display medium layer 500. The drive circuit layer 400 is disposed on the flexible substrate 200 to control the displaying of a screen. The display medium layer 500 is disposed on the drive circuit layer 400, the display medium layer 500 specifically is a display medium such as electronic paper, electrophoresis, and the like.

Please refer to FIG. 6, which is a flowchart of a cutting method for the display panel motherboard provided in an embodiment of the present disclosure. The cutting method is configured to cut the display panel motherboard mentioned as above, and specific steps are as follows.

In a step S601, stripping off a part of a flexible substrate in a non-cutting region, and a rigid substrate.

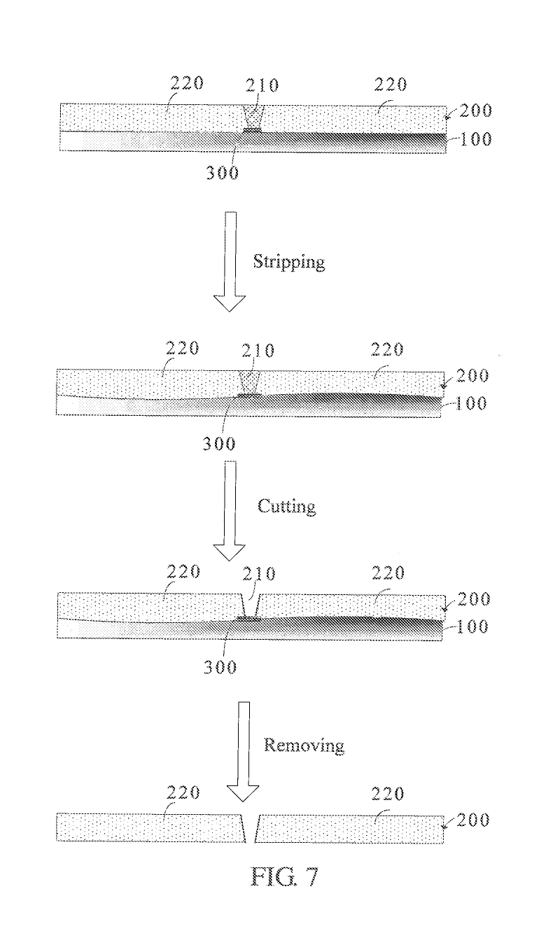

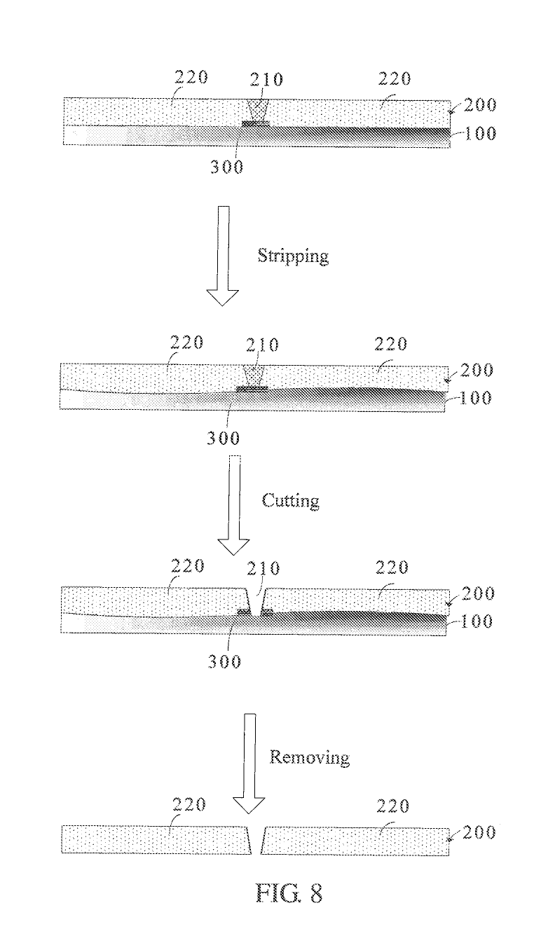

As shown in FIG. 7 and FIG. 8, first, the part of the flexible substrate 200 in the non-cutting region 220, and the rigid substrate 100 are stripped off by technology of laser lift off. Since the fixing layer 300 has a light shielding characteristic being able to shield a laser, the fixing layer 300 will not be stripped off from the part of the flexible substrate 200 in the cutting region 210, and the part of the flexible substrate 200 and the rigid substrate 100 are fixed together through the fixing layer 300.

In a step S602, cutting the flexible substrate along the cutting region of the flexible substrate until the fixing layer is contacted.

Since the flexible substrate 200 may be fixed on the rigid substrate 100 through the fixing layer 300, the flexible substrate 200 which is not aligned to be cut due to being dangling has been avoided. As shown in FIG. 7, the flexible substrate 200 may be cutting along the cutting region 210 of the flexible substrate 200 until the fixing layer 300 is contacted.

In some embodiments, after the step of stripping off the flexible substrate 200 in the non-cutting region 220, and the rigid substrate 100, the method can also be performed, as shown in FIG. 8, cutting the flexible substrate 200 along the cutting region 210 of the flexible substrate 200 until the cutting extends to the rigid substrate 100 for a cutting process of the flexible substrate 200.

In addition, the fixing layer 300 and the flexible substrate 200 may also be separated by mechanical lift off technology. Following removing the rigid substrate 100 and the fixing layer 300, the flexible substrate 200 is obtained, as shown in FIG. 7 and FIG. 8. Then, the flexible substrate 200 is bonded to a back plate to obtain a flexible display device.

A display panel motherboard and a cutting method for the display panel motherboard are provided in embodiments of the present disclosure, the display panel motherboard is produced by disposing the fixing layer between the flexible substrate in the cutting region and the rigid substrate of the display panel motherboard, to fix the flexible substrate on the rigid substrate when the part of the flexible substrate in the non-cutting region and the rigid substrate are stripped off, and the flexible substrate is cut along the cutting region of the flexible substrate, so as to increase a cutting efficiency.

While the present disclosure has been disclosed with reference to preferred embodiments, the above-described embodiments are not intended to limit the present disclosure, and a person having ordinary skill in the art will be able to make various changes and modifications without departing from the spirit and scope of the present disclosure, and thus the scope of the present disclosure is defined by the scope of the claims.

1. A display panel motherboard, comprising: a rigid substrate, a flexible substrate, and a fixing layer, the flexible substrate comprising a cutting region and a non-cutting region;
wherein a part of the flexible substrate in the non-cutting region is adhered to the rigid substrate; and
wherein the fixing layer is disposed between the flexible substrate in the cutting region and the rigid substrate, the fixing layer is configured to fix the flexible substrate on the rigid substrate when the part of the flexible substrate in the non-cutting region and the rigid substrate are stripped off, and the flexible substrate is cut along the cutting region of the flexible substrate.

2. The display panel motherboard as claimed in claim 1, wherein an adhering strength between the fixing layer and the flexible substrate ranges from 1 to 20 gram-force/foot.

3. The display panel motherboard as claimed in claim 1, wherein the fixing layer is made of an opaque material.

4. The display panel motherboard as claimed in claim 1, wherein the cutting region comprises a plurality of cutting sub-regions, the fixing layer comprises a plurality of fixing portions corresponding to parts of the flexible substrate in the cutting sub-regions; and the fixing portions are arranged adjacently or spaced apart.

5. The display panel motherboard as claimed in claim 4, wherein a bottom of one of the fixing portions has a long-bar shape, a round shape, a square shape, or a rounded-square shape.

6. The display panel motherboard as claimed in claim 1, wherein the fixing layer comprises a fixing sub-layer and a light-shielding sub-layer; the light-shielding sub-layer is disposed on the rigid substrate; and the fixing sub-layer is disposed between the flexible substrate and the light-shielding sub-layer.

7. The display panel motherboard as claimed in claim 1, wherein an adhering strength between the part of the flexible substrate in the non-cutting region and the rigid substrate is greater than 50 gram-force/foot.

8. The display panel motherboard as claimed in claim 1, further comprising a drive circuit layer and a display medium layer, the drive circuit layer is disposed on the flexible substrate; and the display medium layer is disposed on the drive circuit layer.

9. A cutting method for a display panel motherboard configured to cut the display panel motherboard as claimed in claim 1, comprising:
stripping off the part of the flexible substrate in the non-cutting region, and the rigid substrate; and
cutting the flexible substrate along the cutting region of the flexible substrate until the fixing layer is contacted.

10. The cutting method for the display panel motherboard as claimed in claim 9, wherein after stripping off the part of the flexible substrate in the non-cutting region, and the rigid substrate, the cutting method further comprises cutting the flexible substrate along the cutting region of the flexible substrate until the cutting extends to the rigid substrate.

11. A cutting method for a display panel motherboard configured to cut the display panel motherboard as claimed in claim 2, comprising:
stripping off the part of the flexible substrate in the non-cutting region, and the rigid substrate; and
cutting the flexible substrate along the cutting region of the flexible substrate until the fixing layer is contacted.

12. A cutting method for the display panel motherboard configured to cut the display panel motherboard as claimed in claim 3, comprising:
stripping off the part of the flexible substrate in the non-cutting region, and the rigid substrate; and
cutting the flexible substrate along the cutting region of the flexible substrate until the fixing layer is contacted.

13. A cutting method for the display panel motherboard configured to cut the display panel motherboard as claimed in claim 4, comprising:
stripping off the part of the flexible substrate in the non-cutting region, and the rigid substrate; and
cutting the flexible substrate along the cutting region of the flexible substrate until the fixing layer is contacted.

14. A cutting method for a display panel motherboard configured to cut the display panel motherboard as claimed in claim 5, comprising:
stripping off the part of the flexible substrate in the non-cutting region, and the rigid substrate; and
cutting the flexible substrate along the cutting region of the flexible substrate until the fixing layer is contacted.

15. A cutting method for a display panel motherboard configured to cut the display panel motherboard as claimed in claim 6, comprising:
stripping off the part of the flexible substrate in the non-cutting region, and the rigid substrate; and
cutting the flexible substrate along the cutting region of the flexible substrate until the fixing layer is contacted.

16. A cutting method for a display panel motherboard configured to cut the display panel motherboard as claimed in claim 7, comprising:
stripping off the part of the flexible substrate in the non-cutting region, and the rigid substrate; and
cutting the flexible substrate along the cutting region of the flexible substrate until the fixing layer is contacted.

17. A cutting method for a display panel motherboard configured to cut the display panel motherboard as claimed in claim 8, comprising:
stripping off the part of the flexible substrate in the non-cutting region, and the rigid substrate; and
cutting the flexible substrate along the cutting region of the flexible substrate until the fixing layer is contacted.
